(19) United States
(12) Patent Application Publication
(10) Pub. No.: US 2021/0389002 A1
(43) Pub. Date: Dec. 16, 2021

(54) Hydrodynamic filter equipment

(71) Applicant: Ngoc Luc PHAM, Hai Phong (VN)

(72) Inventor: Ngoc Luc PHAM, Hai Phong (VN)

(21) Appl. No.: 17/284,442

(22) PCT Filed: Dec. 18, 2019
(86) PCT No.: PCT/VN2019/000022

§ 371 Date: Apr. 10, 2021

(30) Foreign Application Priority Data
Mar. 6, 2019 (VN) 1-2019-01128
May 28, 2019 (VN) 1-2019-02787

(51) Int. Cl. F24F 8/158; F24F 3/167; B01D 53/26; B01D 53/22

(52) U.S. Cl. CPC F24F 8/158; F24F 3/167; F24F 2003/144; B01D 53/22; B01D 53/263

(57) ABSTRACT

The invention refers to hydrodynamic air filter equipment including: The mixing chamber has a cylindrical shape with a circular cross section; the inside contains the cleaning solution; pyramid diffusion structure with tip facing downwards, submerged in the cleaning solution, below the surface of the solution, which diffuses the flow of air and mixes into the solution; the dehumidifying device consists of staggered moisture-sensitive materials, tilting downwards in the direction; the activated carbon is the last layer of action, has a good absorption effect for non-polar substances in the form of gas and liquid, has the effect of deodorizing and retaining bacteria. To supply air to the device, we use power supply clusters including motors, supplying fans. To increase the speed and performance of the device, we use additional exhausting fan clusters including motors, exhausting fans. Membrane filtration prevents large dust particles as well as undesirable harmful materials/agents to the device.

### TECHNICAL ASPECTS

The present invention relates to a hydrodynamic filter equipment, a highly purified air continues to supply ultra clean air chamber input means, in particular, is an indoor clean air to maintain the natural circulation of the ultra clean air supply unit.

### BACKGROUND ART

Together with the increasing of economic development and people's living standards, people are more and more pay attention to health, environmental quality; and human health has a very close relationship, not only for people living environment requirements that need to be increased continuously, but the indoor air quality also putted forward higher requirements. Currently, indoor and outdoor air has not reach people's demand on the clean air, especially in the current fog and haze condition in most cities across the country with wide scope, long time, deep impact that has been exceeding previous years. Fog and haze has brought the great harmfulness to the public health. When facing to fog and haze, people may not only be forced to close the window, dreary stay at home, unable to enjoy the natural normal air, but also not expect to enjoy the clean air. People want to enjoy clean indoor air, keep the air flowing, and eliminate the problems of dust, mosquitoes and outdoor rain that do not affect health and quality of life.

Today, a typical family uses a way of opening windows to maintain good indoor ventilation, using mosquito fences, but can't prevent dust from raging, still tolerating dust intrusion. When it rains they can only close the window, close the door. People are more miserable, because closed all day, households can not solve mold, moist air and dirt in the house, seriously

affecting everyone's health. The industrial filter like: settling chamber (FIG. 1, FIG. 2); inertial filter (FIG. 3); rotating filter (FIG. 4); membrane filter (FIG. 5); spray filter (FIG. 6) are used for industrial purpose.

At present, current market of air purifier or dehumidifier to alleviate the above predicament is very productive, but It still can not meet the demand of indoor air circulation and lack of fresh air. On the current market of air purifier, dehumidifier there are only equipments for air circulation in the room, they are easy to breed bacteria, can not make the free circulation of air. Advanced anti-fog and haze screens devices just take a certain amount of air filters equipments, the effect is not perfective, cannot create real clean, humidity, healthy air.

These devices are either expensive with high cost or backward technology to meet the requirements of ideal air. Generally families are often reluctant to pay the costs. When facing to fog and haze, families with good conditions must not only install anti-fog and haze machines, but also reach the clean air requirements, other requirements but in vain.

Thus, it does not only need to maintain the indoor clean air flow, but also to adjust the indoor temperature and humidity, but also filled with a suitable flavor, healthy air containing negative ions, from the window, so that dust, mosquitoes, rain can not enter indoor, air conditioning also reduces the time.

### DISCLOSURE OF INVENTION

The purpose of the invention is to overcome the above disadvantages. Specifically, it creates a compact dust/air filter, low energy consumption but improved filtration efficiency.

To achieve this purpose, the invention proposes a hydrodynamic air purifier using a combination of the above technologies. The device according to the present invention consists of a vertical cylindrical mixing chamber with a circular section with cleaning solution inside. The pyramid rotating diffusion structure is arranged with the tip down, submerged in the cleaning solution, below the surface of the solution, which diffuses the flow of air and mixes into the solution; the dehumidifying device consists of staggered moisture-sensitive materials, tilting downwards in the direction; the activated carbon is the last layer of action, has a good absorption effect for non-polar substances in the form of gas and liquid, has the effect of deodorizing and retaining bacteria. To supply air to the device, we use power supply clusters including motors, supplying fans. To increase the speed and performance of the device, we use additional exhausting fan clusters including motors, exhausting fans. Membrane filtration prevents large dust particles as well as undesirable harmful materials/agents to the device. To reduce the cleaning liquid losses due to evaporation effect, we use condenser unit assembly in order to cool the air to reduce the temperature of the air being fed into the device, this cooling condenser unit assembly is located on the inlet air intake (after the membrane filtration).

### BRIEF DESCRIPTION OF DRAWINGS

The invention is described in detail according to the priority implementation plans based on the accompanying figures, in which:

FIG. 1 is a schematic diagram showing a simple box-type dust settling chamber;

FIG. 2 is a schematic diagram showing the dust settling chamber, including: FIG. 2. a) is dust settling chamber with many compartments; FIG. 2.b) is dust settling chamber with shields;

FIG. 3 is a schematic diagram showing the structure of inertial type dust filter;

FIG. 4 is a schematic diagram showing the structure of rotating barrel type dust filter;

FIG. 5 is a schematic diagram showing the effervescent type dust filter, including: FIG. 5. a) 1-layer effervescent type dust filter; FIG.S.b) Multi-layer effervescent type dust filter;

FIG. 6 is a schematic diagram showing the dust filter with hollow material;

FIG. 7 is a schematic diagram showing the dust filter following to the first plan to implement the invention;

FIG. 8 is a schematic diagram showing the dust filter following to the second plan to implement the invention.

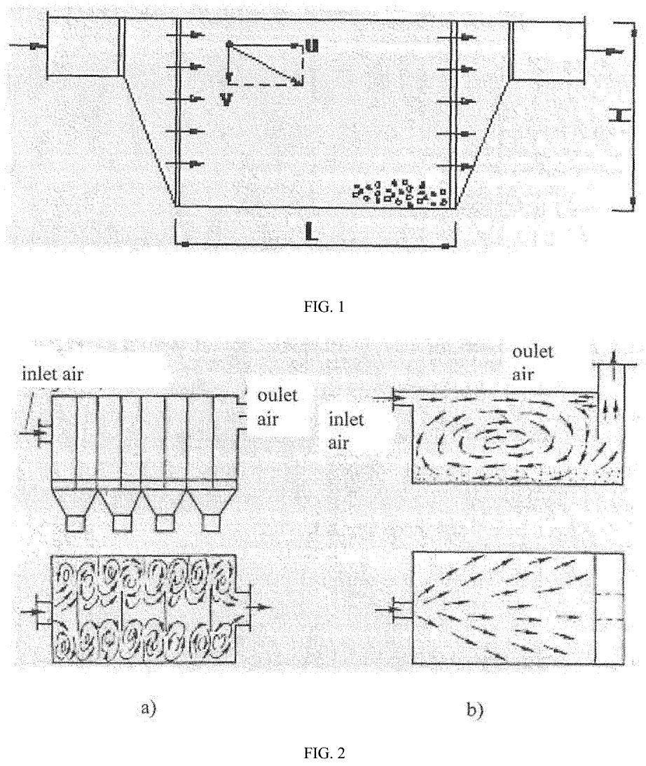

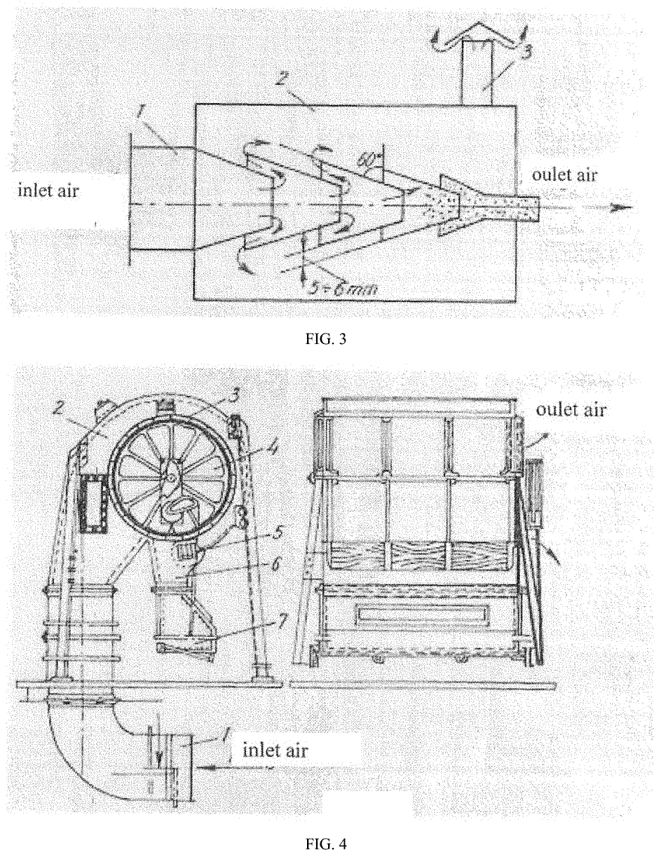

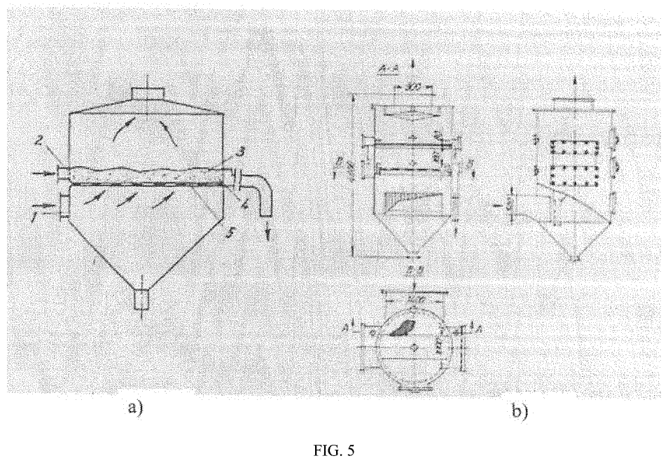

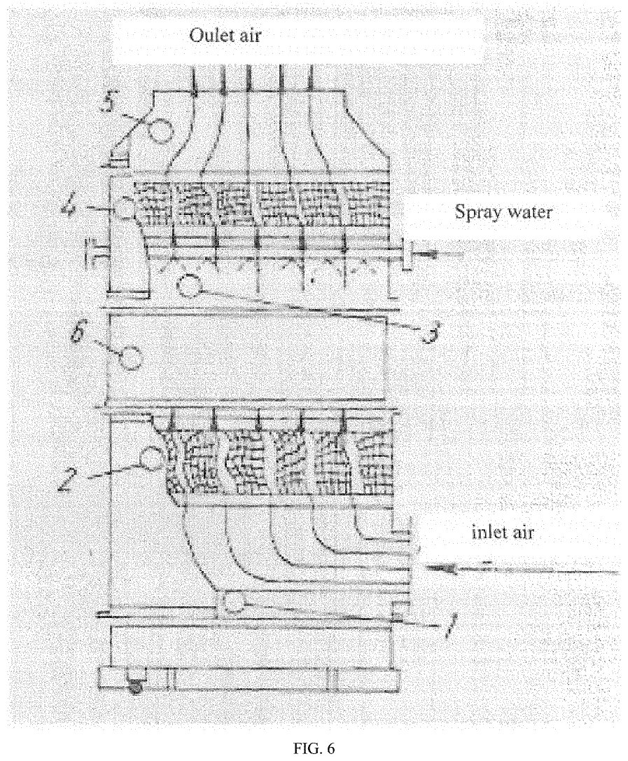

### BEST MODE FOR CARRYING OUT THE INVENTION

The invention is explained in more detail below by the example method using reference to the accompanying figures; including:

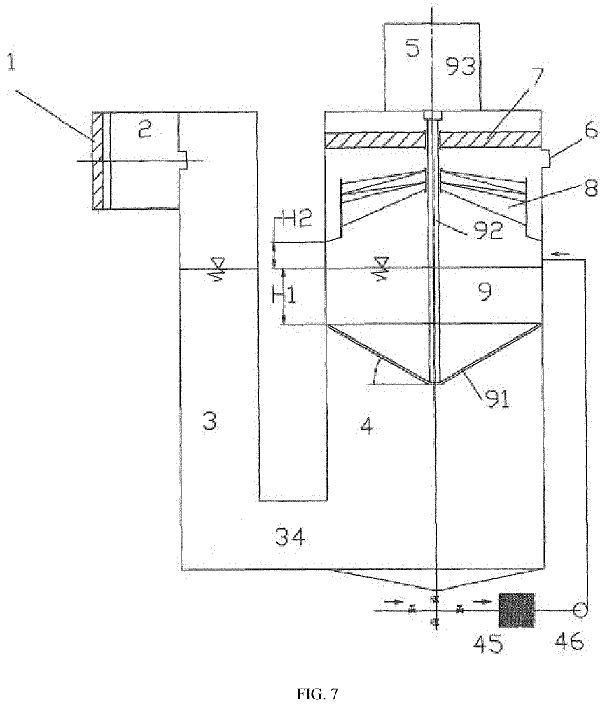

Figure FIG. 7 is showing the filter with two solution compartments 3 and 4, in which, compartment 4 acts as a mixing compartment/mixing chamber, which contains the structure/cluster of structures of the filtration equipment, compartment 3 acts as air path and compensation solution container; mixing compartment/chamber 4 has a vertical cylinder with a circular cross-section with the height size ratio on diameter L4/D4˜3; diffusing structure/mixing structure 9 includes the cone 91 with cone-shape with vertex facing down, made from thin material sheets with perforated holes over its entire area, arranged to be submerged in the cleaning solution, with the edges on the surface of the solution approximately H1, the cone 91 is arranged to rotate around its center axis due to the shaft 92 that is driven by a motor and speed reducer box 93 fixed on top of the mixing chamber. The dehumidifier structure 8 is made of moisture-sensitive material sheets staggered slanting with bottom edge facing outward diameter, the dehumidifier structure is arranged above the surface of the solution and has the lowest part of the bottom layer from the surface of a solution approximately H2. Above the dehumidifying layer is the activated carbon

layer that has the final filtering task before releasing the product to the environment. Port 6 is the location for serial installation of the next mixing chamber when there is a need for higher filtration quality.

Cone 91 with cone shape has a line that produces angle B with respect to the horizontal has the function of increasing the area of the diffuser compared to the same size mixer. The inclination angle B is in the range of 15-60 degrees, if this angle is too large, it will affect the size of the mixing chamber (increase the size of the mixing chamber) and affect the ability to distribute the airflow evenly across the entire working surface of the mixing structure; if this angle is too small, the diffusion efficiency will be reduced due to insufficient diffusion area.

The fact that the cone 91 rotates around its center axis helps dispersing the air bubbles, blending them into cleaning solution more thoroughly. The optimum rotation speed is in the range of 142-157 rounds/minute. If the rotation speed is too large, it will create eddy current, making it difficult for bubbles to pass through the meshes of the cone 91; if the rotation speed is too small, it will reduce the effect of air bubbles dispersion.

According a plan as showing in figure FIG. 9, the edges of holes in the cone 91 have a wing shaped like a pump impeller, creating an angle J in compared to the tangent of the rotation of the cone 91. The wings 991 when rotating will help dispelling the air bubbles and mixing them with cleaning solution more effectively.

According to other plan as showing in figure FIG. 10, the entire of wings 991 create an angle J in compared to the tangent of the rotation of the cone 91.

To create kinetic energy for the air flow that need to be cleaned, we use an air supplying structure 2 including a fan driven by an electric motor. To increase the speed and performance of the device, we use exhausting fan

assembly 5 including motors and exhausting fans. Membrane filtration that prevents large dust particles as well as undesirable harmful materials/agents to the device ds arranged at the input of the device, before the air supplying structure 2.

To reduce the cleaning liquid losses due to evaporation effect, we use condenser unit assembly in order to cool the air to reduce the temperature of the air being fed into the device, this cooling condenser unit assembly is located on the inlet air intake (after the membrane filtration).

The operation of the device: when the device operating, the polluted air is sucked through the membrane filtration by the air supplying structure 2, then filled into compartment 3, and followed the 34 path between compartment 3 and compartment 4 to compartment 4. Due to the kinetic energy of the air stream, the air will split into air bubbles moving upwards. Diffusion structure 9 is responsible for dispersing the air stream to mix with the cleaning solution. The inclined wings 991 help dispersing air bubbles in solution to be more active and thorough, the dust in these air bubbles is retained in the cleaning solution, and the clean air moves up the surface of the solution.

The air after leaving the surface of the solution will have very high humidity, even carrying steam and small particles of water; the dehumidifying structure 8 is responsible for capturing the water vapor and water particles, drying the finished air going through it. The amount of steam retained at the dehumidifying structure 8 will follow inclined walls to spread out to the side walls of the device, then flows downwards.

The activated carbon layer 7 is the final filter structure; it is responsible for deodorizing and retaining bacteria.

To make the cleaning/washing of dust more effective, the distance H1 from the upper edge of the diffuser structure cone 91 to the surface of the

cleaning solution is in the range of 50-100 mm. If the distance is too small, the cleaning effect will not be achieved because the path of air bubbles in the solution is too small, if it is too large, bubbles will accumulate together, which will reduce the cleaning effect.

To make the dehumidifying structure works more effectively, the lower part of the dehumidifying structure should be away from the surface of the cleaning solution a distance of H2˜100-150 mm This distance is sufficient for most of the solution particles after splashes off the solution surface run out of kinetic energy, dropping and returning to the surface of solution. If the distance is too small, the particle of the solution will follow' inertia to latch on the lower part of the dehumidifying structure, which will reduce the effectiveness of the dehumidifying structure. If this distance is too large, it will unnecessarily increase the size of the device. The dehumidifying structure when filled with the solution will create a flow along the inner wall of the mixing chamber and return to the amount of cleaning solution below.

When the device operating, dust in the air will be retained in the cleaning solution, a large amount of them will stick to the inside walls of the device near to the surface of the cleaning solution. To clean the internal surface of the device near the surface of the solution, the air supplying structure 2 can be used with on/off method so that the solution from compartment 3, passing through the path 34 causes the solution in compartment 4 to rise/lower to wash away the dust sticking on the inside walls of the device.

For the function of washing clinging dust more effectively, the ratio of the cross-sectional area of compartment 3/compartment 4 is in the range: S2/S4—1/5-2/5. If this ratio is too large, it will affect the capacity of the air supplying structure, if it is too small, it will not work to clean the dust sticking on the inside walls.

When the device operating, dust in the air will be retained in the cleaning solution. After a period of working time (one working cycle) this solution should be cleaned and be replaced periodically. To accomplish this function, the mixing chamber 4 has a funnel-shaped bottom with the lowest part connected to filter 45 and the circulating pump system 46. After a working cycle (the cycle is installed in the controller), the solution is circulated through the filter by means of a pump system and flow control valve. After several working cycles the solution should be replaced.

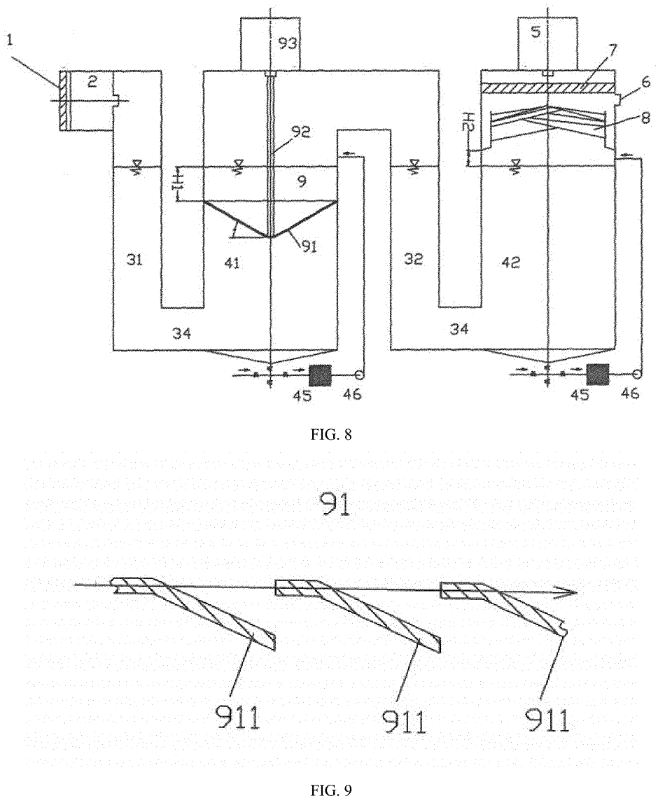

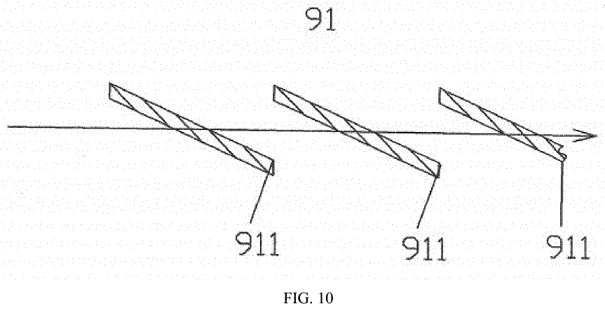

FIG. 8 is showing the filter equipment by another option. According to this plan, the mixing chamber 4 should be split into chamber 41 and 42 connecting by the path 32. The mixing structure 9 is installed in the chamber 41, the dehumidifying structure and the activated carbon layer should be arranged in the chamber 42. Air after being released onto the surface of solution in the mixing chamber 41 will pass through the space 41 1 before following path 32 to the mixing chamber 42. The spacing 411 helps to retain maximum of the solution particles shot up from the surface of the solution in the mixing chamber 41, and the air passing through the mixing chamber 42 will be cleaned again by the solution in before being released to the environment.

Although the description above refers to the device according to the preferred plan of the invention, the description is for illustrative purposes only and is not intended to be used as an introduction of the invention. People with average knowledge in the same field can also make other changes or improvements by referring to the above description. Therefore, the scope of invention protection covers all changes and improvements within the scope of protection of the required accompanying points.

1. Proactive operation hydrodynamic filtration equipment includes two solution containers (3) and (4), in which:
the chamber (4) acts as a mixing compartment/mixing chamber where is containing the components/cluster of components of the filtration equipment;' the chamber (3) acts as air path and compensating solution container; the mixing compartment/mixing chamber (4) has a cylindrical shape with a vertical cross-section, having a ratio of height to the diameter of L4/D4˜3; the mixing compartment/mixing chamber (4) has a funnel-shaped bottom with the lowest part connected to filter (45) and the circulating pump system (46);
diffusing/mixing structure (9) with cone (91) with cone-shape with vertex facing down, made from thin material sheets with perforated holes over its entire area, arranged to be submerged in the cleaning solution, with the edges on the surface of the solution approximately (H1); diffusing structure cone (91) with cone shape has a line that produces angle B with respect to the horizontal has the function of increasing the area of the diffuser compared to the same size mixer; the inclination angle B is in the range of 15-60 degrees the cone (91) is arranged to rotate around its center axis due to the shaft (92) that is driven by a motor and speed reducer box (93) fixed on top of the mixing chamber,
the dehumidifier structure (8) is made of moisture-sensitive material sheets staggered slanting with bottom edge facing outward diameter, the dehumidifier structure is arranged above the surface of the solution and has the lowest part of the bottom layer from the surface of a solution approximately (H2);
above the dehumidifying layer is the activated carbon layer (7) which is responsible for the final filtration before releasing the product to the environment;
port (6) is the location for serial installation of the next mixing chamber when there is a need for higher filtration quality;
air supplying structure (2) includes fan driven by electricity motor that installed at the input of the device, after the membrane filtration (1);
cluster of exhausting fans includes fans driven by electricity motor that installed at the output of the device;
membrane filtration (1) that prevents large dust particles as well as undesirable harmful materials/agents to the device is arranged at the input of the device, before the air supplying structure (2);
condenser assembly for air cooling to reduce the temperature of the inlet air is arranged on the inlet air passage after the membrane filtration, in which:
the distance (H1) from the upper edge of the diffusing structure cone (91) to the surface of the cleaning solution should be in the range of 50-100 mm;
the optimum rotation speed of the cones (91) is in the range of 142-157 rpm;
the bottom part of the dehumidifier should be away from the surface of the cleaning solution an approximate range H2˜100-150 mm;
the ratio of the cross-sectional area of chamber (3)/chamber (4) is in the range of S3/S4˜1/5-2/5;
The mixing chamber (4) has a funnel-shaped bottom with the lowest part connected to filter (45) and the circulating pump system (46);

2. Hydrodynamic filter equipment according to claim 1, in which, the mixing chamber (4) should be split into chamber (41) and (42) connecting by the path (32). The mixing structure (9) is installed in the chamber (41), the dehumidifying structure (9) and the activated carbon layer (7) should be arranged in the chamber (42); air after being released onto the surface of solution in the mixing chamber (41) will pass through the space (411) before following path (32) to the mixing chamber (42); the spacing (411) helps to retain maximum of the solution particles shot up from the surface of the solution in the mixing chamber (41), and the air passing through the mixing chamber (42) will be cleaned again by the solution in before being released to the environment.
